(19) United States
(12) Patent Application Publication
(10) Pub. No.: US 2005/0117899 A1
(43) Pub. Date: Jun. 2, 2005

(54) Digital imaging conversion system for conventional film cameras

(75) Inventor: Evan George Selby, Sacramento, CA (US)

Correspondence Address: Evan George Selby, 2820 Sarina Court, Sacramento, CA, 95826, US

(73) Assignee: Mr. Evan George Selby, Sacramento, CA (US)

(21) Appl. No.: 10/964,599

(22) Filed: Sep. 30, 2004

Related U.S. Application Data
(60) Provisional application No. 60/508,242, filed on Oct. 3, 2003.

(51) Int. Cl. G03B 17/00

(52) U.S. Cl. 396/429

(57) ABSTRACT

The purpose of this invention is to provide all owners of conventional film cameras with a film-shaped digital insert, with which images can be taken, stored, processed and edited using digital equipment without any use of conventional photosensitive film. Image quality would be similar to that of a high-end digital camera for a fraction of the cost, and allow for instant transport and printing of images with any available digital destinations. The system would be completely modular in design, allowing for different sensing, processing, downloading and storage components to be added or removed fitting the needs of the camera equipment they are to be used with.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

There are literally tens of millions of conventional film cameras currently still in operation worldwide, and not all amateur and professional photographers are willing to sell the equipment they have come to know and love and start over with digital systems. The system would actually cost less than a medium—end 35 mm camera body, and allow the photographers to use both conventional film and digital media at the highest resolution with their existing equipment.

As it currently stands in the field of photography, one must have separate systems for both conventional film and digital imaging. The Digifilm system allows a conventional film system the flexibility for both, along with the ability to transport images instantly for review via wireless internet and cellular communications technology.

### BRIEF SUMMARY OF THE INVENTION

A digital hardware system designed to provide photographers with conventional film cameras a digital media alternative to conventional photosensitive film, with the option of allowing interface of components with a variety of storage, media and transport devices. The system could be fitted with a variety of commonly used interface options—Bluetooth, T-Mobile, Universal Serial Bus, Fire Wire, and wireless network devices would all be viable destinations of images captured, edited and stored in the system. Depending on the format of the camera equipment the system would be utilized with, the system may consist of one or more devices, each with many integrated components. The inventory of components of the system would remain the same in all formats, but different size limitations of the film format in the camera to be used, in conjunction with the end destination of the images captured would necessitate different configurations of the system devices.

### BRIEF DESCRIPTION OF THE SEVERAL VIEWS OF THE DRAWINGS

FIG. 1—Depicts Flow of Image Data through the system.

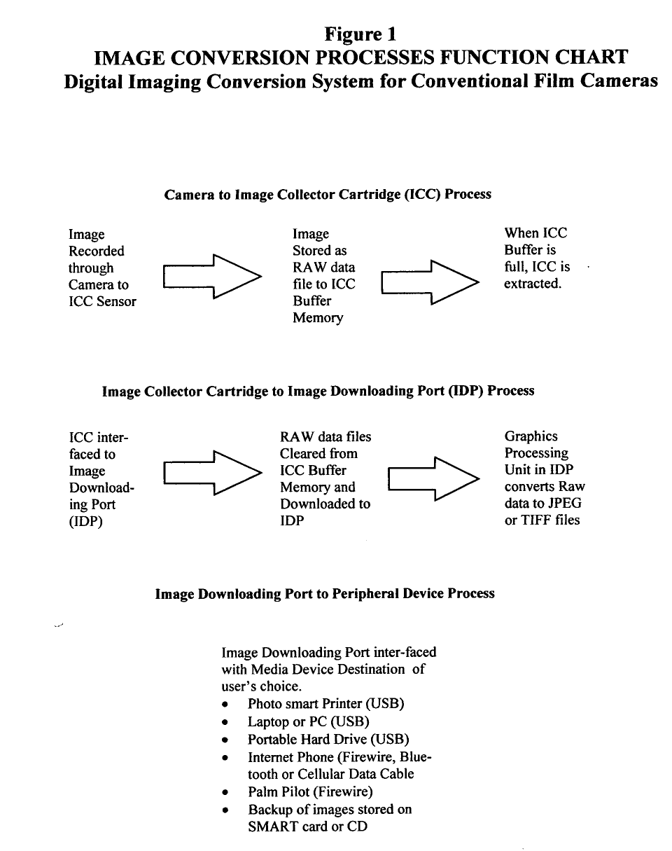

FIG. 2—Depicts Film Plane side view of Image Collector Cartridge, showing and listing internal and external components.

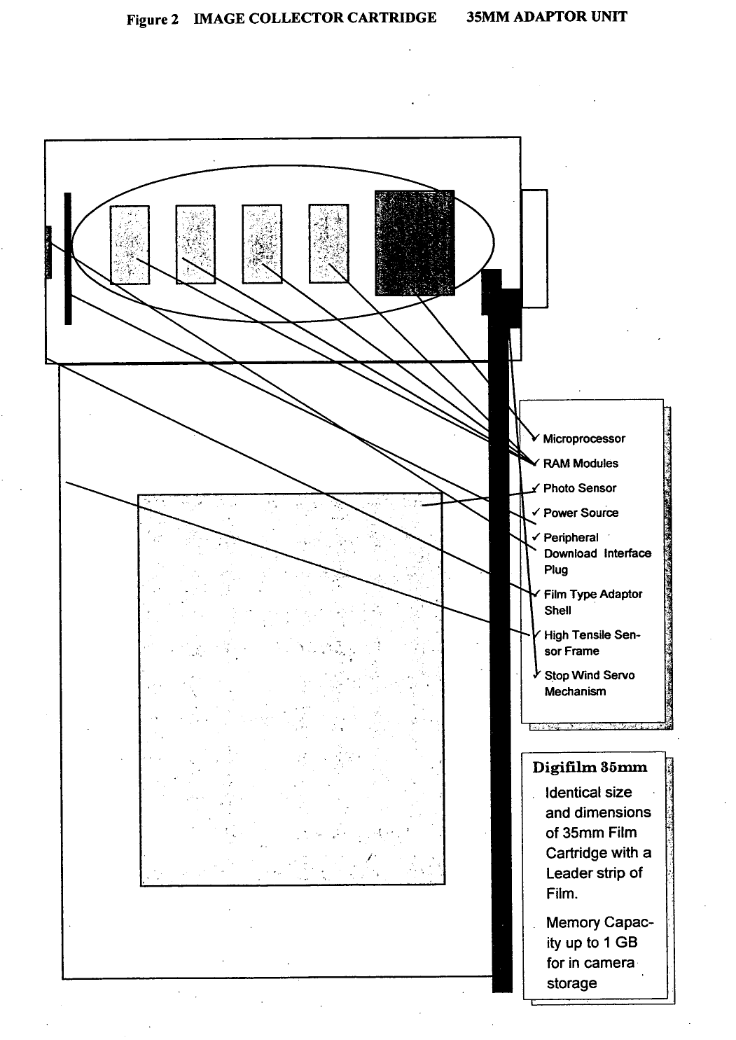

FIG. 3—Depicts external rear and side views of Image Collector Cartridge, showing and listing external components.

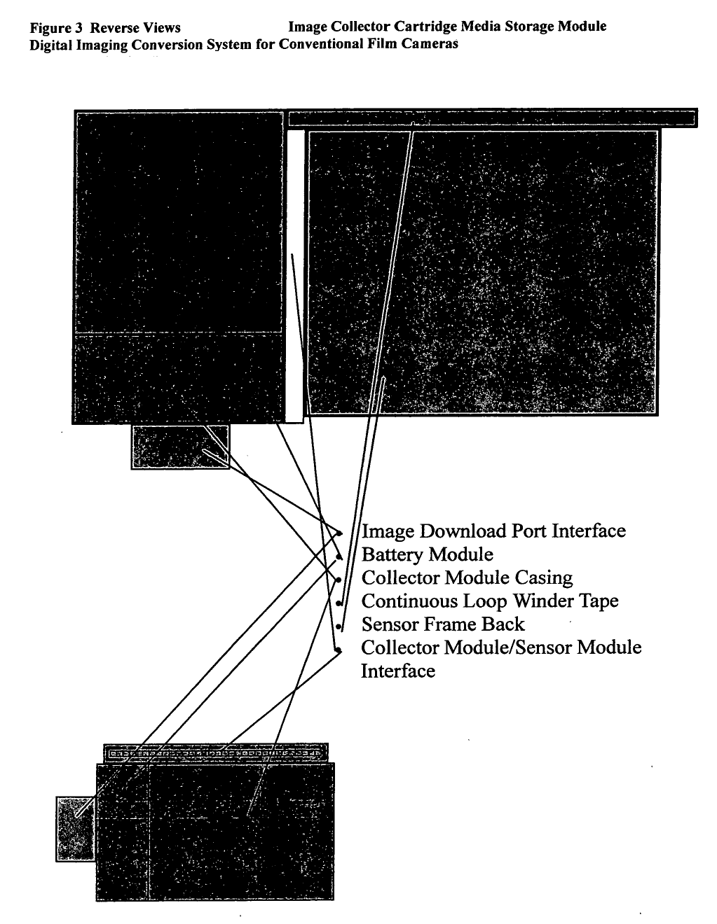

FIG. 4—Depicts external bottom view of Image Collector Cartridge with Image Sensor Module assembled, showing and listing external components.

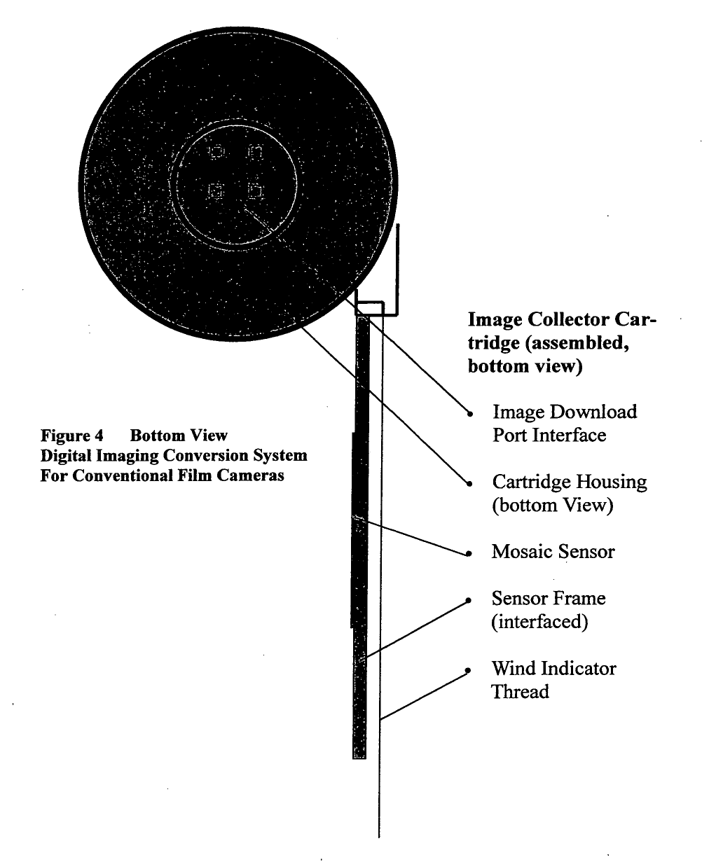

FIG. 5—Depicts external top view of Image Collector Cartridge with Image Sensor Module detached, showing and listing external components.

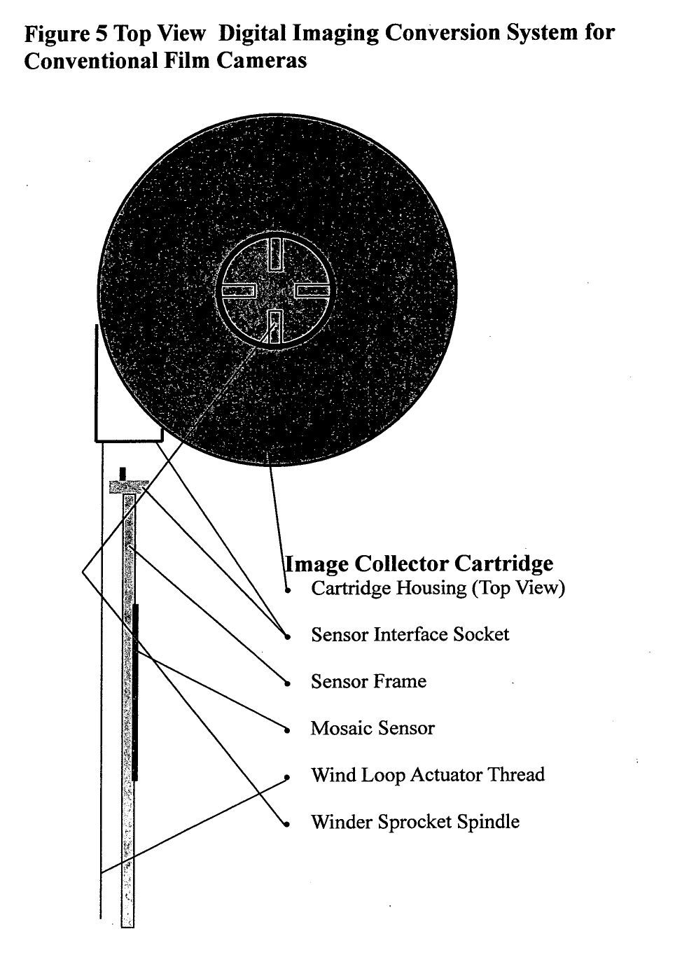

FIG. 6—Depicts Film Plane side view of Image Collector Cartridge for a Large-Format plate film camera, showing and listing internal and external components.

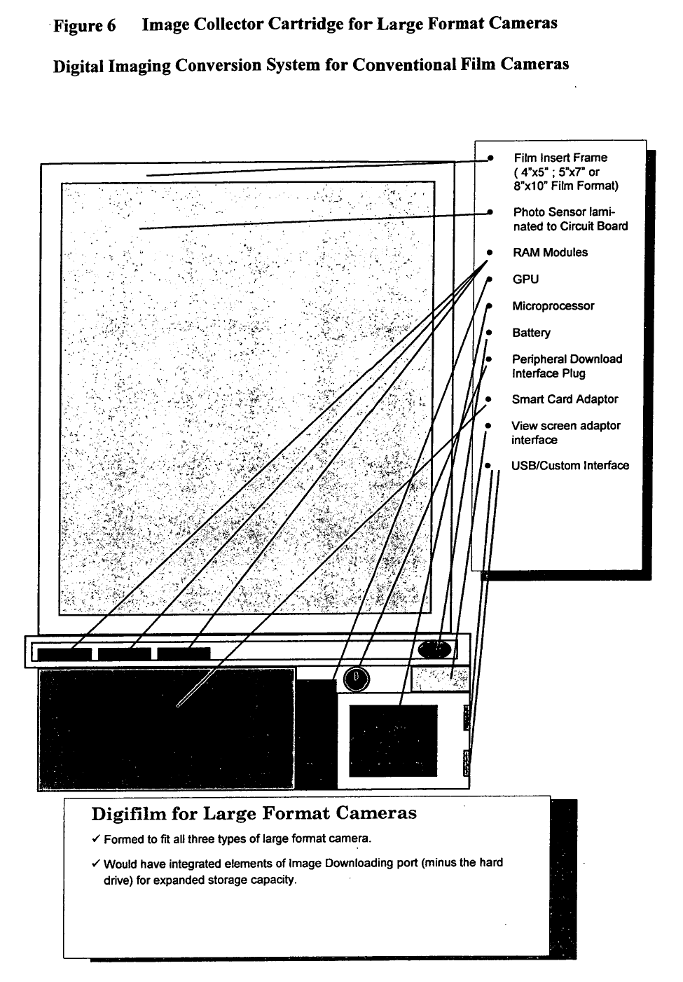

FIG. 7—Depicts Film Plane side view of Image Sensor Module detached from Image Collector Cartridge. Shown are all external components.

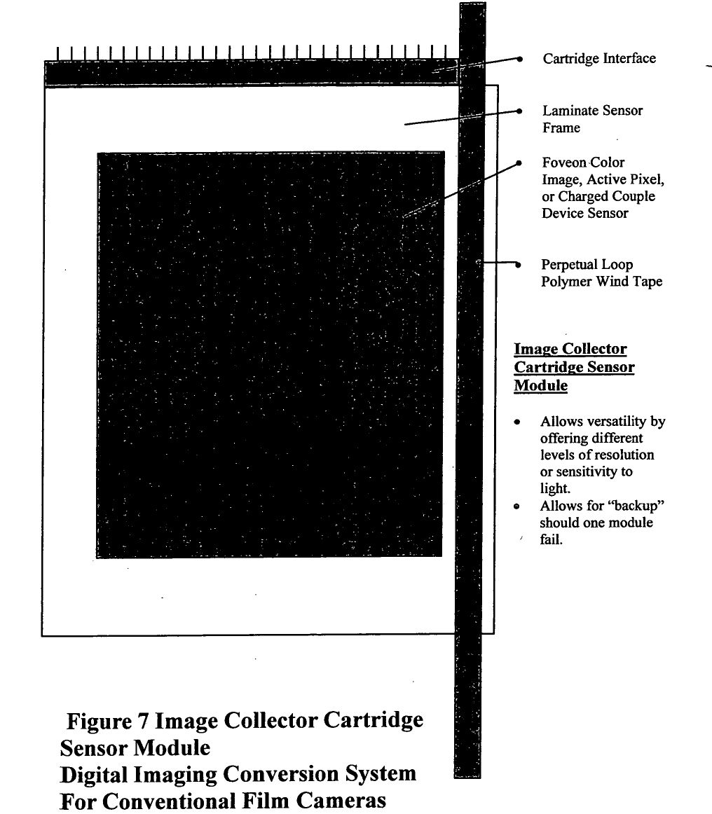

FIG. 8—Depicts all side views of Image Downloading Port, showing and listing all external components.

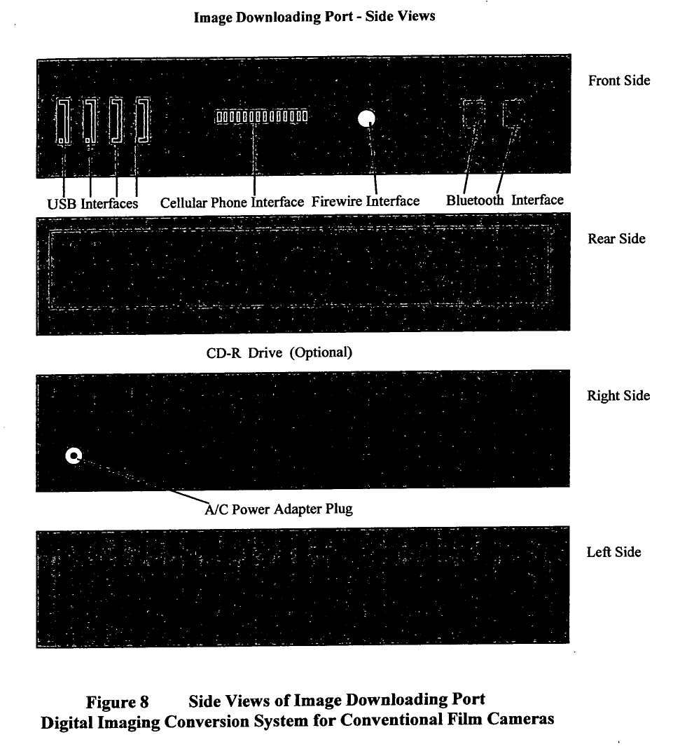

FIG. 9—Depicts Internal top view of Image Downloading Port, showing and listing all internal and external components.

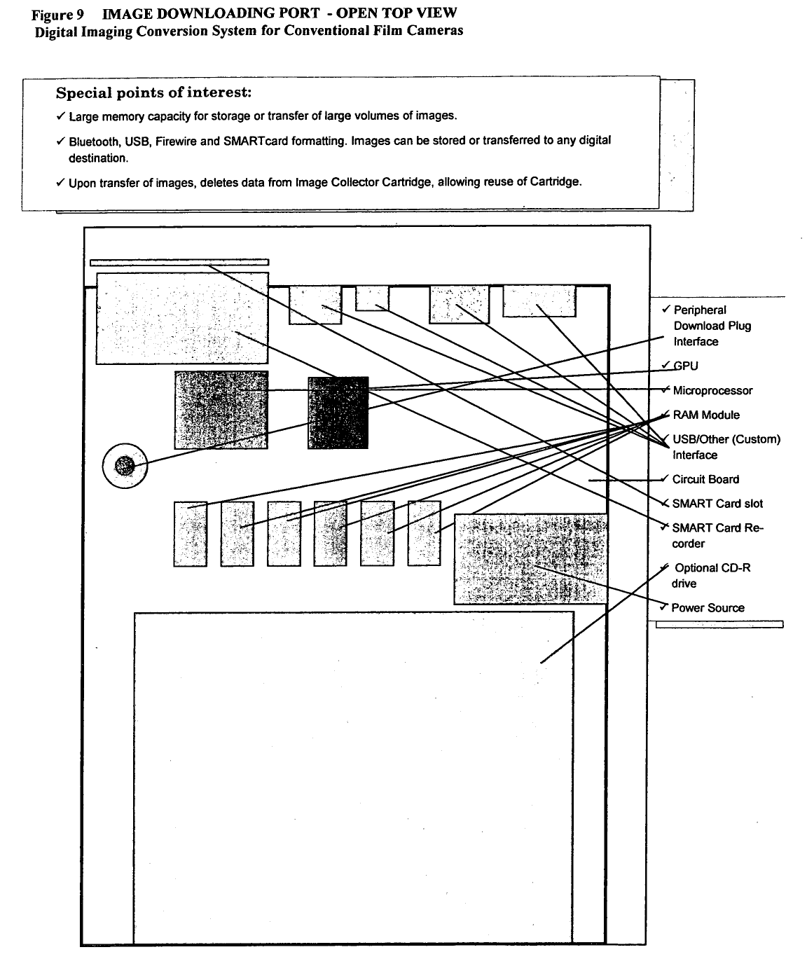

### DETAILED DESCRIPTION OF THE INVENTION

### A. System Overview

The system is a fairly simple concept, comprised of existing hardware components used in Computers, Video Cards and Digital Cameras configure into devices which allow for a digital synthesis of film exposure and processing in any conventional film camera. The configuration of the system devices and components thereof would be dictated by the special constraints of the film format in question. Naturally, a larger film format would allow for more capacity for components in-camera than the smaller film formats.

### B. System Devices

IMAGE COLLECTOR CARTRIDGE—

Consisting of a hollow casing in the shape of whatever film format the camera is to be used with to properly fit inside the camera. The shell of this device could be composed of either pressed metal or molded plastic. Inside the shell of the cartridge would be a small Graphics Processing Unit with RAW file processing capabilities, a large Buffer (Random Access Memory Module), Battery Power Source, Memory Usage Indicator (Stop winder servo device), and Peripheral Download Interface Plug, all fixed to a miniaturized circuit board. Extending from the inside edge of the cartridge over the film plane of the camera would be a card of very thin, high-tensile material covered with a photosensitive laminate on the film-plane side, essentially configured as one film frame sized photovoltaic sensor. The two pieces would interface via pressure pin socket, with the Image Collector Sensor Module allowing for different exposure speed ratings. Once inserted into the camera, the power on the unit would be enabled, and the photographer could begin taking digital images with the camera until the Buffer Memory (RAM) modules inside the cartridge became full and the stop winder servo device signaled that images needed to be downloaded to storage media, emptying the Buffer Memory and allowing the cartridge to be used again. In smaller film formats, the cartridge would need to be interfaced to an Image Downloading Port to achieve this. Larger format cartridges would have the components of both devices integrated in the Image Collector Cartridge.

IMAGE DOWNLOADING PORT—

This device would serve the function of allowing more permanent storage of the images collected, emptying the Buffer Memory of the Image Collector Cartridge, and providing interface with various end-use destinations for the images stored inside it. The Image Downloading Port itself would simply be a plastic or metal box with an assortment of input and output interfaces, as well as a Compact Disc Recorder tray. An internal circuit board would hold a small microprocessor, random access memory, graphics processor, and basic input/output interface ports. To begin processing, the Image Collector Cartridge would connect to the Image Downloading Port via the Peripheral Download Interface Plug. The Image Downloading Port would in turn interface with a number of different media storage, printing and transport devices. Equipped with a Central Processing Unit, more Random Access Memory, mobile rack for a hard drive, smart card writer, Universal Serial Bus, Fire Wire, Blue Tooth, T-Mobile, or wireless network adapter interface as well as a connection for a monitor display, the Image Downloading Port is what truly would give the system the large amount of versatility to make it a commercially viable invention. Various configurations would be completely customizable with modular design segments depending on the needs of the photographer, and the limitations of the equipment the system is utilized with.

1. I, Evan George Selby, claim the invention of the Digital Imaging Conversion System for Conventional Film Cameras as previously described in its' entirety, utilizing a film cartridge shape Image Collector in two pieces that interfaces with either a modular or integrated image processing unit, known as the Image Downloading Port. Modular or Integrated design is solely dependent upon the format of film used. I, evan george selby, claim the invention of the image collector cartridge component, in the shape of a film cartridge with raw data image storage, stop wind servo mechanism, and modular design, including the sensor module, comprised of high tensile material laminated with a mosaic photo sensor, that can be changed to allow for different film iso ratings: I, Evan George Selby, claim the invention of the Image Sensor Module, with interfaces with the Image Collector Cartridge via a friction pin socket. I, Evan George Selby, claim the invention of the Image Downloading Port, which allows for processing, storage and transmission of RAW image files via bluetooth, firewire, cellular phone, computer and printer interface, as well as CD ROM and data card storage through interface with the Image Collector Cartridge.
